(19) United States
(12) Patent Application Publication
(10) Pub. No.: US 2004/0159996 A1
(43) Pub. Date: Aug. 19, 2004

(54) Underbody clamping device

(75) Inventor: Luciano Migliori, Milan (IT)

Correspondence Address: YOUNG & THOMPSON, 745 SOUTH 23RD STREET 2ND FLOOR, ARLINGTON, VA, 22202

(73) Assignee: UNIVER S.P.A., MILAN (IT)

(21) Appl. No.: 10/776,210

(22) Filed: Feb. 12, 2004

(30) Foreign Application Priority Data
Feb. 14, 2003 (IT) MI2003A 000270

(51) Int. Cl. B23Q 3/08

(52) U.S. Cl. 269/32

(57) ABSTRACT

The clamping device comprises a box-shaped body provided with a clamping member movable between a forward position and a backward position. Control means are provided for controlling the movement of the clamping member; the control means comprise a thrust member operatively connected to the clamping member by an articulated quadrilateral system, and a toggle-link, in which the hinge point of the link, in the backward position of the clamping member are disposed on opposite sides of the thrust member. The device also comprises scraping means for cleaning the clamping member and to prevent the infiltration of dirt.

### BACKGROUND OF THE INVENTION

This invention concerns a clamping device for clamping and centring work pieces, in particular realtes to an underbody device for clamping and centring sheet metal parts in the manufacture of motor vehicles, or for other similar uses.

### STATE OF THE ART

Clamping devices are normally used for clamping and centring work pieces, on the edges or through appropriate holes or apertures made in the same work pieces, locking them against a shoulder surface of the clamping device, or against a supporting structure.

A clamping device of the aforementioned type is described in DE 39 36 396. The device comprises a box-shaped body having a longitudinal axis, and a hook shaped clamping member which protrudes from an elongate aperture at the fore end of the box-shaped body; the clamping member is slidably supported by the box-shaped body to perform a movement in a longitudinal and cross direction, between a forward disengaging position and a backward clamping position in which it clamps and locks a work piece.

The device is also provided with a control device operatively connected to the clamping member by an intermediate toggle lever mechanism comprising a connecting link and an articulated quadrilateral system.

The articulated quadrilateral system, in turn comprises a first and a second crank members spaced apart in the direction of the longitudinal axis of the box-shaped body, which are pivotally supported by the same body to rotate according to respective pivotal axes, said crank members being connected to the clamping member by means of respective hinge pins.

One of the cranks, in particular the crank disposed close to the fore end of the box-shaped body, is provided with a lever arm hinged to the connecting link.

The toggle-action connecting link is disposed at a side of the articulated quadrilateral system, and the pivotal and articulation points of the system in the clamped condition of the device, are arranged to be aligned on lines parallel to the longitudinal axis of the control device; this kind of solution requires a considerable amount of space in the cross direction of the device, giving rise to problems in handling work pieces and tools along working lines.

In addition, the longitudinal dimension of the aperture, for the protrusion of the clamping member, at the fore end of the box-shaped body, in the direction of the cross transversal movement of the clamping member is larger than the same clamping member, thereby enabling dirt and dust to penetrate.

Consequently, a solution of this kind involves the need to carry out regular and frequent maintenance and cleaning operations, to remove the dirt inside of the device, so as to prevent operative problems, and in order to prolong the working life of the entire clamping device.

In an attempt to partially solve these problems, DE 201 00 701 proposes and describes a clamping device comprising a box-shaped body and a clamping member connected to an actuator by means of a complex control system comprising a thrust member onto which the clamping member is pivoted.

The clamping member is provided with a cam-shaped aperture for a guide pin secured to the box-shaped body, in order to obtain a sliding and tilting movement to clamp a release a work piece; a solution of this kind however introduces excessive losses and wear due to frictional forces and does not provide sufficiently clamping forces.

In order to limit the penetration of dust and/or dirt, the device comprises two flexible blades inside the box-shaped body, having one edge elastically urged along a respective longitudinal edge of the clamping member.

The use of simple elastically flexible blades however does not prevent the infiltration of dirt into the fore end of the box-shaped body, due to the fact that solid particles of dirt could still penetrate into the clamping device due to the poor cleaning action of the flexible blades.

### OBJECTS OF THE INVENTION

An object of this invention is to provide an underbody clamping device for clamping work pieces, of the aforementioned type, comprising at least one clamping member, which is structurally simple, generates high clamping forces, and at the same time has limited overall dimensions in the cross direction, compared to the prior art devices.

A further object of this invention is to provide a clamping device of the aforementioned type, whereby it is possible to prevent the infiltration of dirt inside the body, thereby increasing its reliability and reducing maintenance costs.

### BRIEF DESCRIPTION OF THE INVENTION

According to a first embodiment of this invention, the above can be achieved by means of a toggle-lever clamping device for clamping work pieces, of the type comprising:

a box-shaped body having a longitudinal axis;

at least one clamping member movably supported between a forward position and a backward position, which extends from an elongated aperture of the fore end of the box-shaped body of the clamping device;

control means for controlling the clamping member, said control means comprising a thrust member operatively connected to the clamping member by a toggle-action connecting link and an articulated quadrilateral system;

the articulated quadrilateral system in turn comprising a first crank member having a lever arm hinged to the toggle link, and a second crank member, said first and second crank members being pivoted to the box-shaped body, respectively being hinged to the clamping member of the device;

characterised in that the toggle-link, in the direction of the longitudinal axis of the box-shaped body, is disposed between the articulated quadrilateral system and the thrust member of the control means; and

in that the hinge points of the toggle-link with the thrust member, respectively with the lever arm of the first crank, in the backward position of the clamping member are disposed on opposite sides of the thrust member of the clamping device.

According to a further feature of this invention, the above can be achieved by means of a clamping device for clamping work pieces, of the type comprising:

a box-shaped body having a longitudinal axis;

at least one clamping member movably supported for clamping a work piece, said clamping member comprising a hook-shaped fore portion protruding from a fore end of the body, and a rear shank operatively connected to a control member designed to conjointly move and tilt the clamping member in respect to said longitudinal axis and in a cross direction of the body, between a forward disengaging position and a backward locking position for the work piece, and

cleaning means for cleaning the clamping member and to prevent infiltration of dirt into the box-shaped body of the device;

characterised in that the fore portion of the clamping member is connected to the rear shank by an intermediate arch shaped connecting portion having front and back longitudinal edges;

in that the cleaning means comprise a closure plate at the fore end of the box-shaped body, said closure plate having an aperture for protrusion of the clamping member, provided with scraping edges; and

in that the front and back longitudinal edges of the intermediate portion of the clamping member, each present a shaped profile which remains in contact with a respective scraping edge of the closure plate, during the movement of the clamping member for locking and disengaging the workpiece.

### BRIEF DESCRIPTION OF THE DRAWINGS

These and further features of the clamping device according to this invention, will be more clearly evident from the following description with reference to the accompanying drawings, in which:

FIG. 1 shows a longitudinal cross-sectional view of a clamping device according to the invention, having the clamping member in a backward position in which it clamps a work piece;

FIG. 2 shows the clamping device of FIG. 1, with the clamping member in a forward position in which it disengages the work piece;

FIG. 3 shows a top view of the device of FIG. 2, devoid of the centring stem.

### DETAILED DESCRIPTION OF THE INVENTION

The general features of this invention will be more illustrated hereunder by means of an exemplificative embodiment.

The clamping device for clamping work pieces according to the invention, as shown in the figures from 1 to 3, comprises a box-shaped body 10 having a longitudinal axis, and at least one clamping member 11, in this case one, operatively connected by an articulated system to a linear actuator.

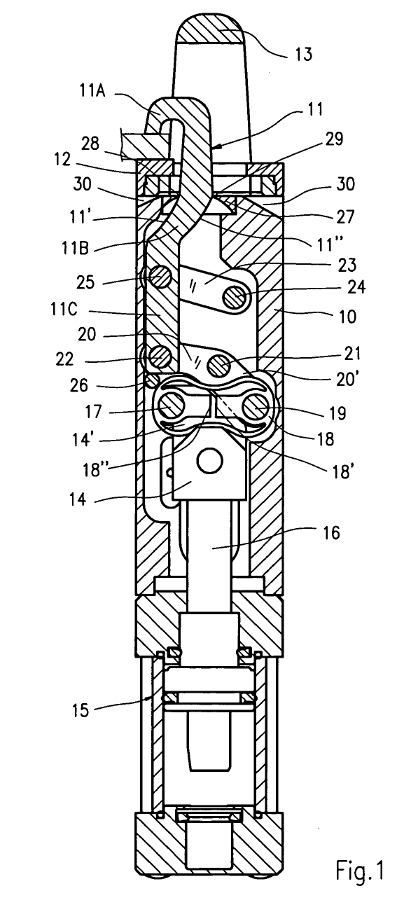

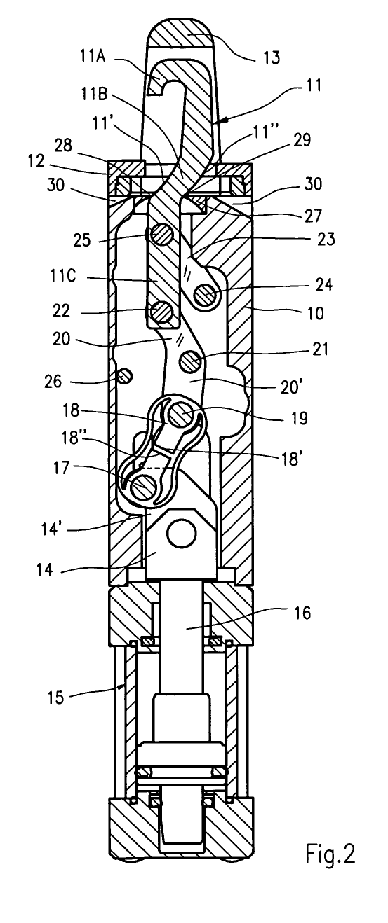

The clamping member 11 comprises a hook-shaped fore portion 11A which partially protrudes from a fore end of the box-shaped body 10, and a rear portion or shank 11C supported by the box-shaped body 10 to perform a longitudinal movement and a cross movement, between a forward disengaging position (FIG. 2) and a backward position (FIG. 1) for retaining a work piece 28 against a shoulder such as a supporting plate 12 secured to the fore end of the body 10.

As will be explained further on, the clamping member 11 extends into a rear shank 11C operatively connected to control means capable of imparting the aforesaid linear and cross movements to engage and disengage the workpiece 28.

More precisely the fore portion 11A of the clamping member 11 is connected to the rear shank 11C by an intermediate arch shaped connecting portion 11B having front and back longitudinal edges 11′ and 11″.

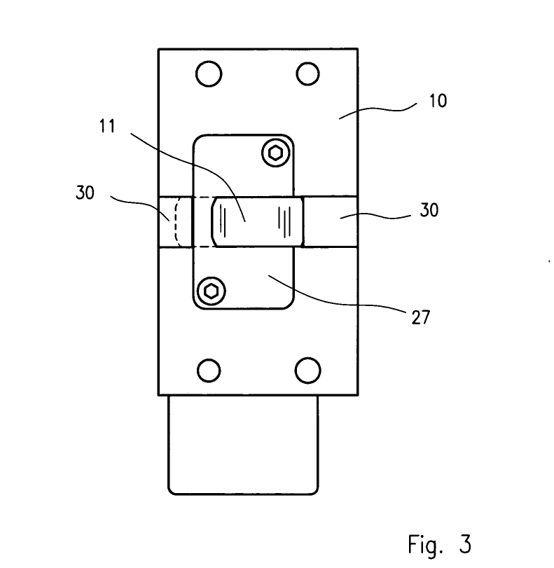

The box-shaped body 10, as shown in the top view in FIG. 3, is rectangular in shape, having one long side and one short side, in which the clamping member 11 is moving parallel to the short side of the box-shaped body 10.

The clamping device can be provided with an hollow centring stem 13, coaxially arranged to the body 10 for centring the work piece, which can be fastened to the fore end of the box-shaped body 10 for example by a supporting plate 12.

The centring stem 13 is provided with a cavity for housing the clamping member 11 in its forward position, as shown in FIG. 2, having a side slit from which the clamping member 11 protrudes in its backward position to clamp a work piece, as shown in FIG. 1.

The clamping device also comprises control means operatively connected to the clamping member 11. The control means comprise a thrust member 14, sliding parallel to the longitudinal axis of the box-shaped body 10, which is operatively connected to an appropriate actuator, such as for example a pneumatic or electric linear actuator 15 having a rod 16 fastened to and movable with the thrust member 14, or to a manually operable control lever, not shown.

Preferentially, the thrust member 14, the box-shaped body 10 and the centring stem 13 are coaxially arranged, so as to provide overall dimensions as small as possible in the cross direction of movement of the clamping member 11.

The thrust member 14 is provided with a fork shaped extention 14′, to which is connected, by means of a hinge pin 17, an intermediate toggle-action connecting link 18, preferably of the axially-controlled and elastically yielding type; the hinge pin 17 of the toggle link 18 is provided on a side and is spaced apart from the sliding axis of the thrust member 14.

The intermediate toggle link 18 is in turn connected, by means of a hinge pin 19, to a lever arm 20′ of a first crank member 20 forming part of an articulated quadrilateral system for supporting the clamping member 11, and is operatively connected to the actuator 15 by a hinge pin 17.

The toggle link 18 and the lever arm 20′ form a toggle-action mechanism, in which the link 18 is configured to be yieldable in the longitudinal direction, and comprises stop means having facing surfaces 18′, 18″ arranged to limit the axial compression of the link upon reaching and overcoming a dead centre condition, while allowing any angular deflection, for compensation of any tollerances of the retained work piece, maintaining a condition of irreversibility of the system once the dead-centre of the toggle mechanism has been overcame.

The articulated quadrilateral system comprises the aforesaid first crank member 20, close to the thrust member 14, which is supported by the box-shaped body 10 to rotate according to a first pivotal axis 21; the crank member 20 is connected to the clamping member 11 by a pin 22 defining a first hinge axis.

The lever arm 20′ of the first crank member 20 is disposed at an angle with respect to the crank member 20 itself, and faces towards the thrust member 14.

Preferably, the longitudinal axes of the lever arm 20′ and the first crank member 20 form an angle ranging from 120° to 160°.

The articulated quadrilateral system also comprises a second crank member 23, disposed towards the fore end of the box-shaped body 10, which is supported to rotate according to a second pivotal axis 24, and is connected to the clamping member 11 by means of a pin 25 defining a second hinge axis.

The first and the second crank members 20 and 23 of the articulated quadrilateral system are of different lengths, such to enable the hook haped end 11A of the clamping member 11 to overpass the work piece during the disengaging and locking movements of the clamping member 11. More precisely the first crank member 20 has a length smaller than the length of the second crank member 23, to conjointly provide a rising or a lowering and a tilting movement of the clamping member 11.

The toggle-link 18, in the direction of the longitudinal axis of the box-shaped body 10, is disposed between the articulated quadrilateral system and the thrust member 14 of the control means; this disposition of the toggle link 18 allows a considerable reduction in the overall dimensions of the device, particularly in the cross direction of the movement of the clamping member 11, thereby considerably increasing the possibilities of moving work pieces and the tools required for the various operations, close to the clamping device along working lines.

Moreover, the toggle-link 18, in the backward position of the clamping member 11, has its hinge point 17 with the thrust member 14, and the hinge point 19 with the arm 20′ of the first crank member 20, which are disposed on opposite sides of the thrust member 14 or more properly of the longitudinal axis of the rod 16 of the actuator, so as to substantially reduce the overall dimension of the clamping device, while allowing the required clamping force.

Conversely, in the forward position of the clamping member 11, the toggle-link 18 has its hinge point 17 on a side of the thrust member 14 and other hinge point 19 substantially aligned with the longitudinal axis of the thrust member 14, as shown in FIG. 2.

In order to allow a correct positioning of the clamping member 11 in the backward position, the box-shaped body 10 comprises a stop element 26 for the same clamping member 11, which prevent an under movement of the articulated quadrilateral system.

The clamping device also comprises scraping and cleaning means capable of preventing the infiltration of dirt through the fore end of the box-shaped body 10; in turn, the cleaning means comprise a closure plate 27, housed in an appropriate seat at the fore end of the box-shaped body 10, which is provided with an elongated aperture for protrusion of the clamping member 11, having first and second cross scraping edges 28,29.

The longitudinal front edge 11′ and the longitudinal back edge 11″ of the intermediate portion 11B of the clamping member 11, each has a shaped profile which remains in contact with a respective scraping edge 28,29 of the closure plate 27 during the movement of the clamping member 11.

For such purpose, the front edge 11′ and the back edge 11″ of the intermediate portion 11B of the clamping member 11 have an arch shaped profile defined by the envelopment of the contact points between the intermediate portion 11B of the clamping member 11, and the cross scraping edges 28,29 of the elongated aperture of the closure plate 27.

Preferentially, the scraping edges 28,29 of the closure plate 27 are sharpened, so as to reduce frictional forces, improving removal of the dirt.

The box-shaped body 10, at the fore end, comprises side slots 30 for discharging the dirt; therefore, the dirt that accumulates over time at the fore end of the box-shaped body 10 is easily removed without having to remove the support plate 12.

The clamping device according to the invention consequently allows a reduction in maintenance costs and is more highly reliably, thanks to the fact that dirt is prevented from infiltrating inside the box-shaped body 10.

What has been described and shown with reference to the accompanying drawings, has been given purely by way of example in order to illustrate the general features of the invention, and of one of its preferred embodiments; therefore other modifications and variations may be made to the clamping device, without thereby deviating from appended claims.

What we claim is:

1. A clamping device for clamping work pieces, of the type comprising:
a box-shaped body having a longitudinal axis;
at least one clamping member movably supported for clamping a work piece, said clamping member comprising a hook-shaped fore portion protruding from a fore end of the body, and a rear shank operatively connected to a control member designed to conjointly move and tilt the clamping member in respect to said longitudinal axis and in a cross direction of the body, between a forward disengaging position and a backward locking position for the work piece, and
cleaning means for cleaning the clamping member and to prevent infiltration of dirt into the box-shaped body of the device;
wherein the fore portion of the clamping member is connected to the rear shank by an intermediate arch shaped connecting portion having front and back longitudinal edges;
wherein the cleaning means comprise a closure plate at the fore end of the box-shaped body, said closure plate having an aperture for protrusion of the clamping member, provided with scraping edges; and
wherein the front and back longitudinal edges of the intermediate portion of the clamping member each present a sharpened profile which remains in contact with a respective scraping edge of the closure plate, during the movement of the clamping member for locking and disengaging the workpiece.

2. A clamping device according to 1, wherein a centring stem for a clamped workpiece is provided at the fore end of the box-shaped body.

3. A clamping device according to claim 2, wherein said centring stem is coaxial arranged to the box-shaped body.

4. A clamping device according to claim 1, wherein in the forward position of the clamping member an hinge point of the toggle link is disposed on a side of the thrust member, while the other hinge point of the toggle link is substantially aligned with the thrust member of the clamping device.

5. A clamping device according to claim 1, wherein the box-shaped body, has a cross-section of rectangular shape having long and short sides, the clamping member being movable parallel to the short side.

6. A clamping device according to claim 1, comprising scraping means for cleaning the clamping member and for preventing the infiltration of dirt at the fore end of the box-shaped body.

7. A clamping device according to claim 5, wherein the box-shaped body, at its fore end, comprises slots for discharging the dirt.

8. A clamping device according to claim 1, wherein the toggle-link is conformed to be elastically yieldable in the axial direction.

9. A clamping device according to claim 1, wherein the first and the second crank members of the articulated quadrilateral system are of different lengths.

10. A clamping device according to claim 9, wherein the first crank member hinged to the toggle link, is shorter then the second crank member.

11. A clamping device according to claim 1, wherein the lever arm of the first crank member is disposed at an angle with respect to the same crank member.

12. A clamping device according to claim 9, wherein the angle between the lever arm and the first crank member is ranging between 120° to 160°.

13. A clamping device according to claim 1, wherein the box-shaped body comprises a stop element for retaining the articulated quadrilateral system in the backward position of the clamping member.

14. A clamping device for clamping work pieces, of the type comprising:
a box-shaped body having a longitudinal axis;
at least one clamping member movably supported for clamping a work piece, said clamping member comprising a hook-shaped fore portion protruding from a fore end of the body, and a rear shank operatively connected to a control member designed to conjointly move and tilt the clamping member in respect to said longitudinal axis and in a cross direction of the body, between a forward disengaging position and a backward locking position for the work piece, and
cleaning means for cleaning the clamping member and to prevent infiltration of dirt into the box-shaped body of the device;
wherein the fore portion of the clamping member is connected to the rear shank by an intermediate arch shaped connecting portion having front and back longitudinal edges;
wherein the cleaning means comprise a closure plate at the fore end of the box-shaped body, said closure plate having an aperture for protrusion of the clamping member, provided with scraping edges; and
wherein the front and back longitudinal edges of the intermediate portion of the clamping member, each present a sharpened profile which remains in contact with a respective scraping edge of the closure plate, during the movement of the clamping member for locking and disengaging the workpiece.

15. A clamping device according to claim 14, wherein the front and back edges of the intermediate connecting portion of the clamping member, have an arch shaped profile defined by the envelopment of the contact points between the longitudinal edges of the same intermediate connecting portion and scraping edges of the closure plate.

16. A clamping device according to claim 14, wherein said closure plate, has shapered scraping edges.
